(19) United States
(12) Patent Application Publication
(10) Pub. No.: US 2009/0220830 A1
(43) Pub. Date: Sep. 3, 2009

(54) ANODE SUPPLY SYSTEM FOR A FUEL CELL STACK AND A METHOD OF PURGING THE SAME

(75) Inventors: Uwe Limbeck, Kirchheim (DE); Cosimo S. Mazzotta, Ulm (DE); Sven Schmalzriedt, Ostfildern (DE); Elmar Schneider, Weilheim (DE)

Correspondence Address: CROWELL & MORING LLP;INTELLECTUAL PROPERTY GROUP, P.O. BOX 14300, WASHINGTON, DC, 20044-4300, US

(73) Assignee: NuCellSys GmbH, Kirchheim/Teck-/Nabern (DE)

(21) Appl. No.: 12/281,111

(22) PCT Filed: Feb. 28, 2006
(86) PCT No.: PCT/EP06/01844

§ 371 Date: Dec. 9, 2008

(51) Int. Cl. H01M 8/04

(52) U.S. Cl. 429/17

(57) ABSTRACT

An anode supply system for a fuel cell stack having an anode section with a gas inlet and a gas outlet includes a sensor device for determining the fuel content inside the anode supply system. A discharge valve is operable to form a gas-conducting connection between the anode supply system and the environment in an open position, and a control device is configured to actuate the discharge valve. The control device controls the discharge valve based on signals from the sensor device, independently of current performance data of the fuel cell stack.

This application is a national stage of International Patent Application No. PCT/EP2006/001844, filed Feb. 28, 2006, the entire disclosure of which is herein expressly incorporated by reference.

### BACKGROUND AND SUMMARY OF THE INVENTION

This invention relates to an anode supply system for a fuel cell stack having an anode section with a gas inlet and a gas outlet, a sensor device for determining the fuel content within the anode supply system, a discharge valve for setting up a gas-conducting connection from the anode supply system to the environment, and a control device that is configured to actuate the discharge valve. The invention also provides a method for operating such a system.

Fuel cell technology is a trendsetting alternative energy source for propulsion in the automotive industry. Unlike the widely common internal combustion engines, this technology does not require fossil fuels, and is more environmentally friendly. However, although fuel cell technology as such has been known for quite some time, implementation problems prevent its introduction into vehicles used for daily road traffic. Gas quality control in the anode section of the fuel cell, for example, is a known problem area in this regard.

International Patent Document WO 2004/105169 discloses a method for controlling a discharge valve that releases gas in the anode section of a fuel cell into the environment. The control system uses a numerical method based on temperature measurement, in which the energy loss due to fuel cell operation with a contaminated fuel is compared to the energy loss resulting from the discharge of the fuel mixture in the anode section.

Japanese Patent Document JP 2003-317752 (Patent Abstracts of Japan) relates to a fuel cell system with a controller to control the suitable point in time for discharging the gas mixture from the anode supply system. The method involves calculation of the hydrogen gas (i.e., fuel) concentration, in the gas mixture of the anode supply system based on the measured average density of the gas mixture. The mass flow of the hydrogen in the anode supply system of the fuel cell system is derived from the calculated hydrogen gas concentration and a measured volume flow rate. In addition, the concentration of contaminating gases in the anode supply system is calculated using the density of the gas mixture. If the mass flow of the hydrogen drops below a threshold value, while at the same time the concentration of contaminating gases rises above a threshold value, the gas mixture is discharged from the anode supply system.

Japanese patent document JP 2000-243417 (Patent Abstracts of Japan), which may be the closest to the state of the art, relates to a fuel cell system having a highly complex apparatus for refreshing the gas mixture in the anode supply system. Control of the refreshing system is designed as a multiple control system in which the operating voltage of the fuel cell, among other variables, is used as a reference input.

One object of this invention is to provide an anode supply system and a corresponding method that are simple to implement and operate, cost-effective and immune to interference.

This and other objects and advantages are achieved by the anode supply system according to the invention, which is suitable (and/or designed) for use with a fuel cell stack. The fuel cell stack, which preferably includes multiple fuel cells (although in less preferred embodiments it may comprise a single fuel cell), is preferably designed for mobile use, (such as for installation in a passenger car). Moreover, it may be driven by hydrogen as a fuel, and in particular designed as a PEM type (proton exchange membrane and/or polymer electrolyte membrane) fuel cell. It is also preferred that the fuel cell stack be connected to a hydrogen tank that can be filled from outside and/or can be connected to such tank and/or reformer-free.

The fuel cell stack comprises an anode section in which the fuel is at least partially subjected to the electrochemical reaction, such anode section including a gas inlet for supplying a fuel-containing gas mixture and a gas outlet for discharging the residual gas mixture that remains after the electrochemical reaction. The gas inlet and gas outlet are fluidically interconnected via the anode supply system, thereby permitting recirculation of the gas mixture or residual gas mixture.

The anode supply system further comprises a sensor device for determining the fuel content within the anode supply system. The sensor preferably is designed to receive a single measurand and/or comprises a particular sensor that is to be brought into direct (particularly physical) contact with the gas mixture in the anode supply system. The sensor is preferably designed for measuring electrical parameters of the gas mixture.

A discharge valve is provided to bring the anode supply system into a gas-conducting connection with the environment, so that a portion of the gas mixture and/or the residual gas mixture is discharged (that is, “purged”) into the environment when the discharge valve is opened. A control device, preferably a programmable processing unit, particularly a microcontroller, DSP, or the like, is provided to operate the discharge valve.

According to the invention, the control device controls the discharge valve based on the signals of the sensor device, while the control function is independent of the actual electrical performance data of the fuel cell stack. In particular, the control function is independent of the current fuel cell voltage.

The rationale behind the invention is to propose a solution as simple as possible for an energy-saving purge process of the anode supply system of a fuel cell stack. It was found that multivariable systems in principle give a more accurate reflection of the overall system, and thus facilitate more accurate control. However, such multivariable systems are highly complex and susceptible to interference and require a great number of components for driving the manufacturing effort of a fuel cell system through the roof. It was surprisingly found that stable operation of a fuel cell can also be achieved using a relatively simple control device.

In a preferred embodiment of the invention, the sensor device is designed as or comprises a hydrogen sensor, whose measuring principle is preferably based on measuring electric parameters of the gas mixture in the anode supply system. The reaction time of the hydrogen sensor (i.e., the time required for measuring the measurand) is preferably greater than 0.3 s and/or smaller than 2 s. While the hydrogen sensor can in principle be installed at any position within the anode supply system, it is preferably in the vicinity (and best in the immediate vicinity) of the gas inlet and/or gas outlet of the fuel cell stack or the fuel cell.

In one especially simple embodiment, only the sensor signals from the sensor device are taken into account as input signals (in particular, as measuring signals) for controlling the discharge valve. This embodiment makes use of the proposition that control of the discharge valve can be performed exclusively based on the sensor signal from the sensor device.

Another preferred embodiment relates to the position of the discharge valve within the anode supply system. The discharge valve is arranged in such a way that the gas inlet and/or gas outlet of the fuel cell stack is switched into a gas-conducting connection with the environment when the discharge valve is open, even if the fuel cell stack is not interconnected. In particular, there are no functional elements between the discharge valve on the one hand and the gas inlet and/or outlet on the other. Especially, there are no check valves, that would limit or prevent the gas flow, in particular in the direction of the discharge valve.

Advantageously, the control device may comprise a controller and/or a closed-loop control system, while a setpoint value for the fuel content inside the anode supply system is or can be predefined as a required value. Advantageously, the controller may be a closed-loop control circuit that regulates the hydrogen concentration in the anode supply system.

In an improvement of this embodiment, upper and lower setpoint values are predefined, the lower setpoint value indicating a minimum fuel content and the upper setpoint value indicating a maximum fuel content, respectively, in the anode supply system. It may also be provided that an upper and/or a lower tolerable deviation can be predefined for at least one or both of the two setpoint values. The tolerable deviation can be given as an absolute value or relative to the setpoint value(s).

Preferably, the lower setpoint value can be used to control the opening of the discharge valve, so that the gas mixture is discharged into the environment; and the upper setpoint value can be used for closing the discharge valve, so that the gas-conducting connection with the environment is blocked. In particular, the discharge valve is opened when the lower setpoint value is reached (that is, at a predefined minimum fuel content in the gas mixture in the anode supply system), while the discharged gas mixture is preferably replaced with fuel from a reservoir via a fuel supply system. When the upper setpoint value is reached (i.e., when the predefined maximum fuel content is in the gas mixture inside the anode supply system), the discharge valve is closed, and the fuel supply is preferably deactivated as well. Alternatively, the discharge valve is opened when the lower tolerable deviation is exceeded and closed again when the upper tolerable deviation is exceeded.

The discharge valve may be a proportional valve which can be actuated continuously or in a stepped pattern by the control device. The control device is preferably designed for simultaneous continuous or stepless actuation of the fuel supply system.

In another variation of the anode supply system, the at least one setpoint value and/or the at least one tolerable deviation can be set permanently (that is, as a system parameter). In yet another embodiment, the at least one setpoint value and/or the at least one tolerable deviation depend(s) on other operating parameters of the fuel cell and/or the anode supply system and are adjusted dynamically. Such operating parameters may include instantaneous load demand that is available, for example, by scanning an “accelerator pedal,” the actual pressure or actual temperature inside the fuel cells, especially in the anode and cathode sections.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic block diagram of an embodiment of the anode supply system, together with a fuel cell; and

FIG. 2 is a functional diagram of an embodiment of the method according to the invention.

### DETAILED DESCRIPTION OF THE DRAWINGS

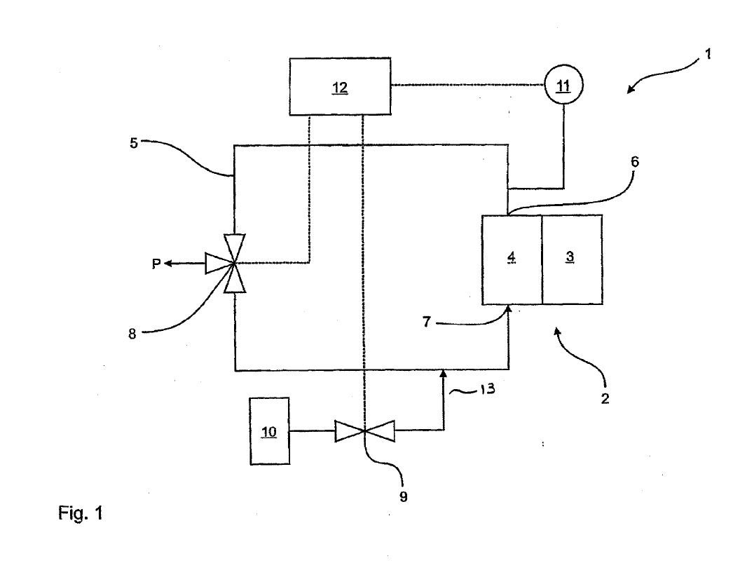

FIG. 1 is a diagrammatic view of the components of a fuel cell system 1 that includes a fuel cell 2, with a cathode section 3 and an anode section 4, and an anode supply system 5. The fuel cell 2 may be, for example, a PEM design, in which the anode section 4 and the cathode section 3 are separated by a membrane (not shown). The cathode supply and other functional groups which are well known to those skilled in the art, have also been omitted in FIG. 1, for the sake of simplicity.

The anode supply system 5 is a gas mixture conducting system which is connected at a gas outlet 6 and a gas inlet 7 of the anode section 4; it is designed and/or arranged so that the gas mixture is recirculated from a gas outlet 6 into the gas inlet 7 via a pump (not shown). The anode supply system 5 further includes an outlet valve 8, a hydrogen supply valve 9 via which a hydrogen tank 10 is connected, a hydrogen sensor 11, and a control device 12. The control device 12 is designed to receive sensor signals from the hydrogen sensor 11, and to send control signals to the discharge valve 8 and the hydrogen supply valve 9.

Starting from the gas outlet 6 or the fuel cell 2, the next downstream functional element (in the direction of flow of the gas mixture) is the hydrogen sensor 11 (or a measuring point of the hydrogen sensor), followed by the discharge valve 8. In its closed position, the gas discharge valve forms a gas-conducting connection in the direction between the gas outlet 6 and the gas inlet 7 of the fuel cell 2, while in the open position, it forms a gas-conducting connection between the gas outlet 6 and/or the gas inlet 7 on the one hand and the outside environment on the other. The discharge valve 8 may be designed as a control valve that steplessly switches from the open position to the closed position and vice versa.

Alternatively, the discharge valve 8 can be designed as a proportional valve which takes a continuous switching position depending on the control signal from the control device 12. An inlet 13 that allows adding hydrogen to the gas mixture and/or replenishing the gas mixture with hydrogen from a hydrogen tank 10 that can be filled from outside, is provided downstream from the discharge valve 8. A hydrogen supply valve 9 that adjusts the gas flow into the inlet 13 depending on the control signal from the control device 12 is provided downstream (in gas flow direction) of the hydrogen tank 10. The next element downstream from the inlet 13 is the gas inlet 7 into the fuel cell 2 or into the anode section 4 of fuel cell 2.

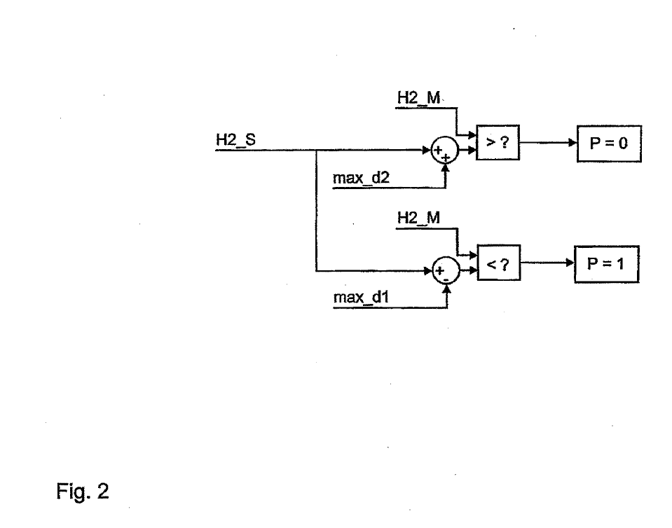

The hydrogen content in the gas mixture that is discharged from the anode section 4 of the fuel cell 2 is measured by the hydrogen sensor 11, and the measured value is transmitted in the form of a sensor signal to the control device 12. There, it is compared to a predefined setpoint in the control device 12 (explained below with reference to FIG. 2), and the discharge valve 8 and/or the hydrogen valve 9 are actuated based on this comparison.

If the measured hydrogen content drops below the predefined setpoint value (or in addition drops below a predefined tolerable deviation), the discharge valve 8 is opened to discharge (“purge”) the gas mixture from the anode supply system 5 into the environment. At the same time, hydrogen is introduced from the hydrogen tank 10 via the inlet 13 by opening the hydrogen supply valve 9 so that the hydrogen content in the anode supply system 5 increases.

If the measured content of the hydrogen in the gas mixture exceeds a predefined threshold value (or exceeds a predefined tolerable deviation therefrom), the discharge valve 8 and/or hydrogen supply valve 9 are closed again. A pressure sensor (not shown) that monitors the gas pressure in the anode supply system 5 can optionally be provided so that the hydrogen supply valve 9 is closed only when the gas pressure reaches another predefined setpoint value.

FIG. 2 shows a functional diagram of how the anode supply system 5 shown in FIG. 1 is actuated. A setpoint value for the hydrogen content in the gas mixture H2_S in the anode supply system 5 as well as a first maximum deviation max_d1 and a second maximum deviation max_d2 are predefined as actuating variables, the two deviations being specified either absolutely and/or in relation to the H2_S setpoint. It is also possible that the value of the two deviations are the same. Another input value provided to the actuation system is the actual measured value of the hydrogen content H2_M in the gas mixture of the anode supply system 5.

During regular operations, the first maximum deviation max_d1 is subtracted from the H2_S setpoint value while the discharge valve 5 is closed, and the result is compared to the actual H2_M value. If the actual measured value H2_M is smaller than the result of the subtraction, a control signal P is set to the value 1 (open) so that the discharge valve 8 is opened and the gas mixture is released from the anode supply system 5 into the environment. In other words:

(H2_S−max_d1)>H2_M==>P=1 and H₂ concentration rises due to addition of H₂ via valve 9.

Further down the diagram, the closing process of the discharge valve 5 is also actuated, preferably by adding the second maximum deviation max_d2 to the setpoint value H2_S and by once again comparing the result with the measured value H2_M. If the actual measured value H2_M exceeds the result of the addition, the control signal P is set to 0 (closed) so that the discharge valve 8 is closed. In other words:

(H2_S+max_d1)<H2_M==>P=0 Exhaust gas remains in supply system and H₂ decreases.

In alternative embodiments, the discharge valve 8 and/or the hydrogen supply valve 9 may not be limited to switching between an open and closed state, but are operable in a stepless manner and in proportion to a similarly stepless control signal P from the control device 12. It can also be configured that the setpoint values or the tolerable deviations are constants or, alternatively, dynamically adjusted depending on operating parameters.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-11. (canceled)

12. An anode supply system for a fuel cell stack having an anode section with a gas inlet and a gas outlet, said anode supply system comprising:
a sensor device for determining a fuel content inside the anode supply system;
a discharge valve that is operable to form a gas-conducting connection between the anode supply system and the environment in an open position; and
a control device that is configured to actuate the discharge valve; wherein,
the control device controls the discharge valve based on signals from the sensor device, independently of current performance data of the fuel cell stack.

13. The anode supply system according to claim 12, wherein the sensor device comprises a hydrogen sensor.

14. The anode supply system according to claim 12, wherein the signals from the sensor device constitute the sole input to the control device for controlling the discharge valve.

15. The anode supply system according to claim 12, wherein the discharge valve is configured in such a way that the anode supply system can be switched into a gas-conducting connection with the environment when the discharge valve is open, without interconnecting the fuel cell stack.

16. The anode supply system according to claim 12, wherein the control device comprises one of a controller and a closed-loop control system for which a setpoint value for the fuel content (H2_S) inside the anode supply system is predefinable as the required value.

17. The anode supply system according to claim 16, wherein a lower setpoint value and an upper setpoint value for the hydrogen content in the anode supply system are predefinable.

18. The anode supply system according to claim 16, wherein at least one of an upper (max_d2) and a lower (max_d1) tolerable deviation, can be predefined for the at least one setpoint value (H2_S).

19. The anode supply system according to claim 18, wherein:
the lower setpoint value is used to cause opening of the discharge valve; and
the upper setpoint value is used to cause the closing of the discharge valve.

20. The anode supply system according to claim 12, wherein the discharge valve comprises a proportional valve that is actuatable by the control device in a manner that is one of continuous, stepless and in a stepped pattern.

21. The anode supply system according to claim 12, wherein at least one of the at least one setpoint value (H2_S) and the at least one tolerable deviation (max_d1, max_d2) depend on other operating parameters.
